(19) United States
(12) Patent Application Publication
(10) Pub. No.: US 2026/0249185 A1
(43) Pub. Date: Aug. 27, 2026

(54) ONE OR MORE COMPUTER-READABLE STORAGE MEDIA, GAME SYSTEM, AND COMPUTER-IMPLEMENTED METHOD

(71) Applicant: NINTENDO CO., LTD., Kyoto (JP)

(72) Inventors: Toshiaki SUZUKI, Kyoto (JP); Osamu TSUCHIHASHI, Tokyo (JP)

(21) Appl. No.: 19/643,383

(22) Filed: Apr. 9, 2026

Related U.S. Application Data
(63) Continuation of application No. PCT/JP2023/037077, filed on Oct. 12, 2023.

(51) Int. Cl. A63F 13/56; A63F 13/428; A63F 13/525; G06F 3/0346; G06F 3/0354

(52) U.S. Cl. CPC A63F 13/56; A63F 13/428; A63F 13/525; G06F 3/0346; G06F 3/03543

(57) ABSTRACT

An example of a game system includes a mouse having a sensor that detects movement on a work surface. When the mouse is moved on the work surface, a first object is moved on a virtual surface. When the mouse is lifted from the work surface, the first object is moved in a direction away from the virtual surface.

### CROSS REFERENCE TO RELATED APPLICATION

This application is a continuation of International Patent Application No. PCT/JP2023/037077 filed on Oct. 12, 2023, the entire contents of which is incorporated herein by reference.

### FIELD

The technique shown here relates to game instructions, an information processing method, and an information processing system that allow a game to be played using a mouse.

### BACKGROUND AND SUMMARY

Conventionally, there are games in which a game operation is performed by moving a mouse on a work surface.

However, there was room for improvement in order to play various games using a mouse.

An exemplary embodiment discloses game instructions, an information processing method, and an information processing system that allow a novel game using a mouse to be played.

An exemplary embodiment adopts the following configurations.

### First Configuration

Game instructions of a first configuration cause one or more processors to perform a movement process of moving a first object along a virtual surface in a virtual space based on first data output in response to movement of a mouse on a work surface. Also, the game instructions cause the one or more processors to perform a separation process of moving the first object in a direction away from the virtual surface based on second data output in response to the mouse being lifted from the work surface.

According to the above, the first object can be moved along the virtual surface when the mouse is operated on the work surface, and the first object can be moved in the direction away from the virtual surface when the mouse is lifted from the work surface, and an intuitive and novel game can be played using the mouse.

### Second Configuration

In a second configuration, in the first configuration, in the separation process, regardless of an amount that the mouse is lifted from the work surface, the first object may be separated from the virtual surface by a predetermined movement amount.

According to the above, regardless of the lifting amount of the mouse, the first object can be separated from the virtual surface by a predetermined movement amount.

### Third Configuration

In a third configuration, in the first or second configuration, when a condition is satisfied in a state where the first object is separated from the virtual surface, the first object may be returned to a position along the virtual surface even when the mouse is lifted from the work surface.

According to the above, regardless of whether or not the mouse is lifted from the work surface, the first object can be returned to a position along the virtual surface when the predetermined condition is satisfied.

### Fourth Configuration

In a fourth configuration, in any of the first to third configurations, an image looking down on the virtual surface from above the virtual space is generated based on a virtual camera, and when the mouse is lifted from the work surface, in the separation process, the first object may be moved in a direction away from the virtual surface toward the virtual camera.

According to the above, an image bird's-eye viewing the virtual surface is displayed, and when the mouse is lifted from the work surface, the first object can be moved in a forward direction.

### Fifth Configuration

In a fifth configuration, in any of the first to fourth configurations, the mouse includes a direction input unit, and when the mouse is lifted from the work surface and the first object is separated from the virtual surface, the first object may be moved according to an input on the direction input unit.

According to the above, the first object separated from the virtual surface can be moved according to the operation on the direction input unit.

### Sixth Configuration

In a sixth configuration, in the fifth configuration, when the mouse is on the work surface, the first object may be configured not to be moved according to the input on the direction input unit.

According to the above, when the mouse is on the work surface, the first object can be prevented from being moved according to the operation on the direction input unit, and the first object can be moved according to the movement of the mouse on the work surface.

### Seventh Configuration

In a seventh configuration, in the fifth or sixth configuration, when the mouse is returned onto the work surface after the first object is moved according to the input on the direction input unit while the first object is separated from the virtual surface, the first object may be arranged at a position along the virtual surface according to a position after being moved according to the input on the direction input unit.

According to the above, when the first object is moved according to the operation on the direction input unit after the first object is separated from the virtual surface, the first object can be returned to a position along the virtual surface according to the position after the movement.

### Eighth Configuration

In an eighth configuration, in any of the first to seventh configurations, the game instructions may cause the one or more processors to control an attitude of the first object according to an attitude of the mouse when the mouse is lifted from the work surface.

According to the above, in a state where the mouse is lifted from the work surface, the attitude of the first object can be controlled according to the attitude of the mouse.

### Ninth Configuration

In a ninth configuration, in any of the first to eighth configurations, the game instructions may cause the one or more processors to move a second object based on a user input or a predetermined algorithm. Also, the game instructions may cause the one or more processors to execute a first process if the mouse is lifted from the work surface when the first object and the second object are in a first positional relationship with respect to a virtual surface direction.

According to the above, the first process can be performed according to the positional relationship between the first object and the second object, and a game using the second object can be played.

### Tenth Configuration

In a tenth configuration, in the ninth configuration, the game instructions may cause the one or more processors to control the attitude of the first object according to the attitude of the mouse and to execute a second process regarding the second object that was in the first positional relationship when the mouse is lifted from the work surface.

According to the above, when the mouse is lifted from the work surface, the second process can be performed regarding the second object.

### Eleventh Configuration

In an eleventh configuration, in any of the first to tenth configurations, the game instructions may cause the one or more processors to move a third object along the virtual surface based on a user input or a predetermined algorithm. Also, the game instructions cause the one or more processors to execute a third process if the first object and the third object are in a second positional relationship when the mouse is on the work surface, and may be configured not to execute the third process when the mouse is lifted from the work surface.

According to the above, in addition to the first object, the third object can be moved along the virtual surface, and the third process can be executed when the first object and the third object are in the second positional relationship.

### Twelfth Configuration

In a twelfth configuration, in any of the first to eleventh configurations, the game instructions may cause the one or more processors to move a fourth object based on a user input or a predetermined algorithm. Also, the game instructions may cause the one or more processors to execute a fourth process if the first object moved in the direction away from the virtual surface and the fourth object are in a third positional relationship.

According to the above, the fourth process can be executed when the first object moved in the direction away from the virtual surface and the fourth object are in the third positional relationship.

### Thirteenth Configuration

In a thirteenth configuration, in any of the first to twelfth configurations, the mouse may include a first mouse and a second mouse. The game instructions cause the one or more processors to move the first object along the virtual surface according to movement of the first mouse and the second mouse on the work surface, and may move the first object in the direction away from the virtual surface in response to the first mouse and the second mouse being lifted from the work surface.

According to the above, the first object can be controlled using a plurality of mice.

Further, another configuration may be an information processing system that executes the above processes, or may be an information processing method including the above processes.

According to an exemplary embodiment, a novel game can be played using a mouse.

### BRIEF DESCRIPTION OF THE DRAWINGS

FIG. 1 shows an exemplary illustrative non-limiting drawing of an example of a configuration of a game system 1.

FIG. 2 shows an exemplary illustrative non-limiting drawing of an example of an appearance when a mouse 10 is placed on a work surface.

FIG. 3 shows an exemplary illustrative non-limiting drawing of an example of an appearance when the mouse 10 is viewed from a back side.

FIG. 4 shows an exemplary illustrative non-limiting drawing of a state when the mouse 10 is lifted.

FIG. 5 shows an exemplary illustrative non-limiting drawing of a state of a virtual space when a first game is performed in the game system 1.

FIG. 6 shows an exemplary illustrative non-limiting drawing for explaining an operation of each object when a lifting operation is performed on the mouse 10 during execution of the first game.

FIG. 7 shows an exemplary illustrative non-limiting drawing of a state in which a paper scooper object 31 moves in response to an operation being performed on a direction input unit 16 in a state where the mouse 10 is lifted.

FIG. 8 shows an exemplary illustrative non-limiting drawing of an example of various data used for game processing related to the first game.

FIG. 9 shows an exemplary illustrative non-limiting drawing of a flowchart showing an example of game processing related to the first game.

FIG. 10 shows an exemplary illustrative non-limiting drawing of a flowchart showing an example of a during-lifting process of step S107.

FIG. 11 shows an exemplary illustrative non-limiting drawing of each object arranged in the virtual space when a second game is performed.

FIG. 12 shows an exemplary illustrative non-limiting drawing for explaining an operation of each object when a lifting operation is performed on the mouse 10 during execution of the second game.

FIG. 13 shows an exemplary illustrative non-limiting drawing of each object arranged in the virtual space when a third game is performed.

FIG. 14 shows an exemplary illustrative non-limiting drawing for explaining an operation of each object when a lifting operation is performed on the mouse 10 during execution of the third game.

### DETAILED DESCRIPTION OF NON-LIMITING EXAMPLE EMBODIMENTS

### Configuration of Game System

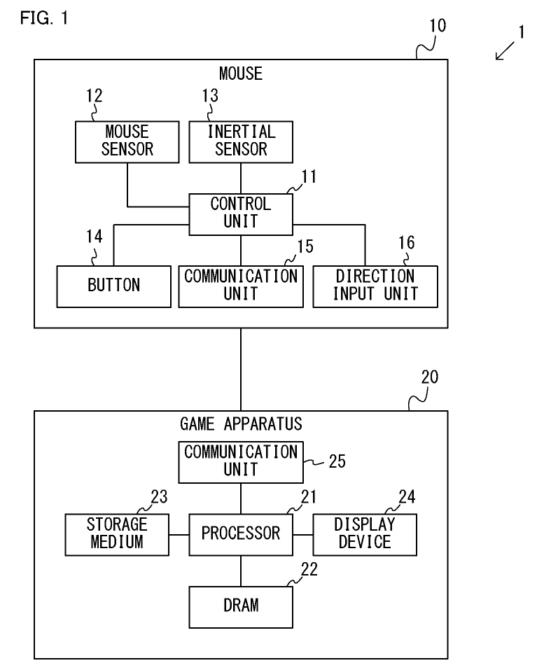

Hereinafter, a game system according to an example of an example embodiment will be described. FIG. 1 is a diagram showing an example of a configuration of a game system 1. As shown in FIG. 1, the game system 1 in this example embodiment includes a mouse 10 and a game apparatus 20. The mouse 10 is placed on a work surface such as a desk or a floor, for example, and is moved on the work surface. The mouse 10 includes a sensor for detecting movement on the work surface. Note that the work surface may be a curved surface instead of a flat surface. Also, the work surface does not necessarily have to be a horizontal surface such as a desk or a floor surface, and may be inclined with respect to the horizontal plane, or may be a wall surface. The work surface may be a human body surface such as a leg, for example.

For example, the mouse 10 is used to indicate a position in a virtual space or on a screen of a display device, and has a size that can be held by a user with one hand. The mouse 10 may be an optical mouse using a red, blue, or infrared LED, or may be a laser type mouse. Also, the mouse 10 may be a mechanical mouse. Hereinafter, the mouse 10 will be described as a mouse having a light source such as an LED or a laser.

As shown in FIG. 1, the mouse 10 includes a control unit 11, a mouse sensor 12, an inertial sensor 13, a button 14, a communication unit 15, and a direction input unit 16. Also, the mouse 10 has a battery (not shown). The control unit 11 is connected to the mouse sensor 12, the inertial sensor 13, the button 14, the communication unit 15, and the direction input unit 16, and controls operations of the mouse 10.

The mouse sensor 12 is a sensor for detecting movement on a work surface such as a desk or a floor, for example. The mouse sensor 12 includes an image sensor, a control circuit, a light source, and a lens. The image sensor outputs an image of the work surface by receiving reflected light of light irradiated to the outside by the light source through the lens. The control circuit calculates movement (movement direction and movement amount) of the mouse 10 on the work surface based on a plurality of images from the image sensor. As the light source, a red or blue LED, an infrared LED, a laser, or the like is used.

The inertial sensor 13 is a sensor for detecting movement and attitude of the mouse 10. As an example, the inertial sensor 13 includes an acceleration sensor and an angular velocity sensor. The acceleration sensor outputs data according to acceleration in each of XYZ axes fixed to the mouse 10. The angular velocity sensor outputs data according to angular velocity around each of the XYZ axes. The control unit 11 can calculate the movement and attitude of the mouse 10 based on data from the acceleration sensor and/or the angular velocity sensor. Note that the inertial sensor 13 may include only one of the acceleration sensor and the angular velocity sensor.

The button 14 includes an operation member pressed by the user and a switch that detects that the operation member is pressed. The mouse 10 includes a plurality of buttons 14 (buttons 14a and 14b described later).

The direction input unit 16 is an input unit for inputting a direction. The direction input unit 16 may be an analog stick that inputs a direction by tilting an operation member in an arbitrary direction. Also, the direction input unit 16 may be an analog pad that inputs a direction by sliding an operation member in an arbitrary direction. Also, the direction input unit 16 may be a cross key capable of inputting up, down, left, and right directions.

The communication unit 15 communicates with a communication unit 25 of the game apparatus 20. The communication unit 15 of the mouse 10 and the communication unit 25 of the game apparatus 20 may be connected by wire or may be connected wirelessly. For example, when the mouse 10 is moved on the work surface, the control unit 11 transmits data regarding the movement direction and movement amount on the work surface from the mouse sensor 12 to the communication unit 15. The communication unit 15 outputs data regarding the movement direction and movement amount from the control unit 11 to the communication unit 25 of the game apparatus 20. Also, the control unit 11 calculates the movement and attitude of the mouse 10 based on data from the inertial sensor 13, and transmits data regarding the movement and attitude to the communication unit 15. The communication unit 15 outputs data regarding the movement and attitude from the control unit 11 to the communication unit 25 of the game apparatus 20. Also, the control unit 11 transmits data according to operations on the button 14 and the direction input unit 16 to the communication unit 15, and the communication unit 15 transmits the data to the communication unit 25 of the game apparatus 20.

Also, the game apparatus 20 includes a processor 21, a DRAM 22, a storage medium 23, a display device 24, and a communication unit 25. The processor 21 is connected to the DRAM 22, the storage medium 23, the display device 24, and the communication unit 25. The processor 21 includes one or more processors. For example, the processor 21 includes one or more CPUs (Central Processing Units) and one or more GPUs (Graphics Processing Units). The CPU performs information processing according to predetermined instructions. For example, the CPU executes game instructions described later. The processor 21 may be composed of an SoC (System-on-a-chip) including one or more CPUs and one or more GPUs.

The DRAM 22 is a memory used for temporarily storing various data used in information processing. The processor 21 performs predetermined information processing (for example, game processing described later) using the DRAM 22. The storage medium 23 is, for example, a non-volatile memory, and stores various data such as game instructions and image data used for a game. The storage medium 23 may be an HDD, an optical disk, or the like. Also, the storage medium 23 may be provided inside the game apparatus 20 in advance, or may be detachably connected to the game apparatus 20.

The display device 24 displays an image generated by the GPU of the processor 21. As the display device 24, an arbitrary display device such as a liquid crystal display device or an organic EL display device may be used. Also, a touch panel may be provided on a screen of the display device 24. Also, the game apparatus 20 includes a speaker and a microphone not shown. Note that the game apparatus 20 may include an output unit for outputting images and sounds to an external display device (for example, a television) different from the display device 24. The game apparatus 20 does not have to include the display device 24, the speaker, and the microphone.

The communication unit 25 communicates with the communication unit 15 of the mouse 10 by wire or wirelessly.

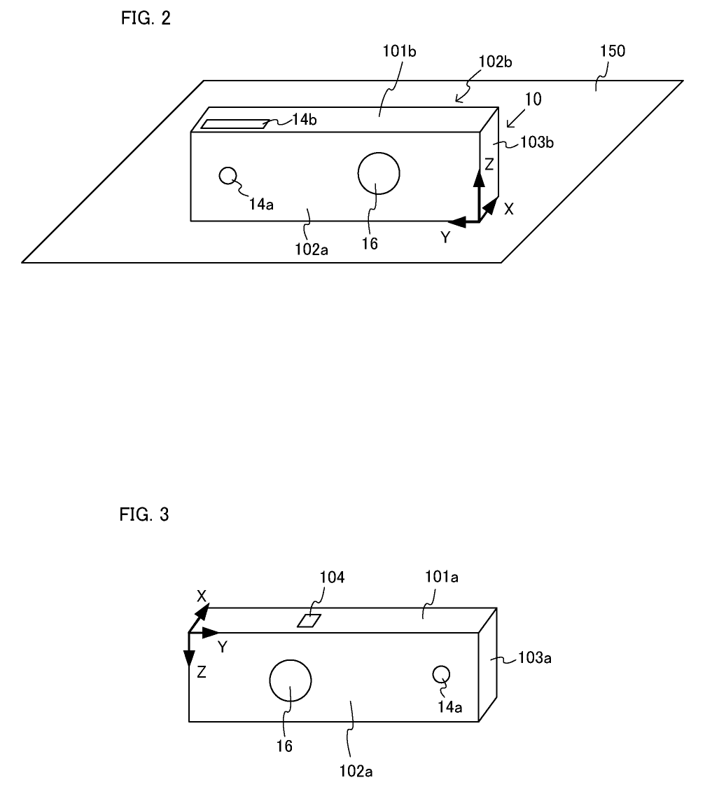

Next, an appearance of the mouse 10 will be described with reference to FIGS. 2 and 3. FIG. 2 is a diagram showing an example of an appearance when the mouse 10 is placed on a work surface. FIG. 3 is a diagram showing an example of an appearance when the mouse 10 is viewed from the back side.

As shown in FIGS. 2 and 3, the mouse 10 has, for example, a substantially rectangular parallelepiped shape. An XYZ orthogonal coordinate system is set for the mouse 10. For example, the X-axis is a rightward axis of the mouse 10, and the Y-axis is a longitudinal axis. The Z-axis is an axis in a height direction and is an axis perpendicular to the X-axis and the Y-axis.

The mouse 10 includes a bottom surface 101a (XY plane) and an upper surface 101b opposite to the bottom surface 101a. An opening 104 is provided in the bottom surface 101a of the mouse 10. The opening 104 exposes the lens of the mouse sensor 12 to the outside. Light from the light source exiting from the opening 104 is reflected on the work surface facing the bottom surface 101a, and the image sensor receives the reflected light.

Also, the mouse 10 includes a left side surface 102a that is a surface substantially perpendicular to the bottom surface 101a and substantially parallel to the YZ plane. A button 14a and a direction input unit 16 are provided on the left side surface 102a. Note that the button 14a may include a plurality of buttons. Also, the button 14a and the direction input unit 16 may be provided on a right side surface 102b opposite to the left side surface 102a. Also, the mouse 10 includes a front surface 103a substantially parallel to the XZ plane and a rear surface 103b opposite to the front surface 103a.

Also, a button 14b is provided on the upper surface 101b of the mouse 10. Note that the button 14b may include a plurality of buttons.

As shown in FIG. 2, the mouse 10 is placed on a work surface 150 such that the bottom surface 101a faces the work surface 150 (that is, such that the upper surface 101b faces upward). For example, when operating the mouse 10 with the right hand, the user places the palm on the upper surface 101b such that the index finger touches the button 14b, and moves the mouse 10 on the work surface 150. The image sensor of the mouse sensor 12 repeatedly takes images of the work surface at predetermined time intervals. The control circuit of the mouse sensor 12 calculates movement (movement direction and movement amount) of the mouse 10 on the work surface 150 by detecting movement of unevenness on the work surface based on a plurality of images from the image sensor.

Note that the appearance of the mouse 10 shown in FIGS. 2 and 3 is merely an example, and the shape of the mouse 10 may be anything. For example, the mouse 10 may include a substantially planar bottom surface 101a provided with an opening 104, and an upper surface 101b having a generally rounded, substantially egg-shaped shape that follows a shape of the user's palm. Also, the mouse 10 may have a substantially rectangular parallelepiped shape in which some corners of the rectangular parallelepiped are formed in an R-shape. For example, a connection portion between the upper surface 101b and the front surface 103a may be formed by a curved surface, and the button 14b may be provided over the upper surface 101b and the front surface 103a.

Also, the control unit 11 may calculate the movement (movement direction and movement amount) of the mouse 10 instead of the mouse sensor 12 (the control circuit thereof) calculating the movement. Also, the mouse sensor 12 or the control unit 11 may calculate a current position relative to a certain reference position in addition to calculating the movement direction and movement amount of the mouse 10 on the work surface (or instead of calculating the movement direction and movement amount). In this case, the mouse 10 transmits the calculated position to the game apparatus 20 in addition to (or instead of) the movement direction and movement amount. Also, an image from the mouse sensor 12 may be transmitted to the game apparatus 20, and the game apparatus 20 may calculate the movement direction and movement amount of the mouse 10 based on the image, and calculate a position indicated by the mouse 10.

Also, the movement and attitude of the mouse 10 may be calculated in the game apparatus 20 instead of the mouse 10. In this case, the mouse 10 transmits data from the inertial sensor 13 to the game apparatus 20, and the game apparatus 20 calculates the movement and attitude of the mouse 10 based on the data.

Also, the attitude of the mouse 10 may be calculated based on data from the mouse sensor 12 instead of data from the inertial sensor 13. For example, when two mouse sensors 12 are provided in the Y-axis direction, it can be calculated whether or not the mouse 10 is inclined with respect to the work surface (whether or not it is rotated around the X-axis) based on data from the two mouse sensors 12. For example, if one of the two mouse sensors 12 can acquire an appropriate image and the other cannot acquire an appropriate image, it can be determined that the Y-axis is inclined upward or downward.

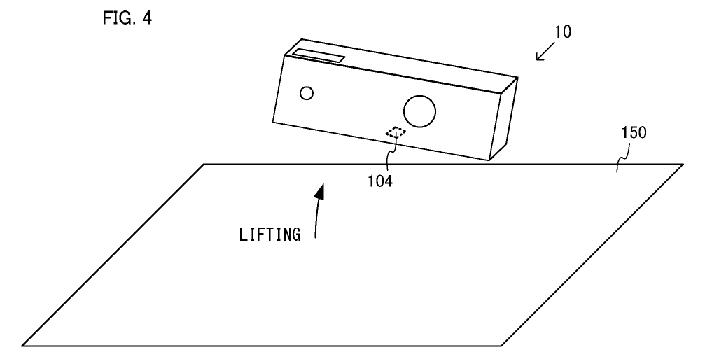

FIG. 4 is a diagram showing a state when the mouse 10 is lifted. As shown in FIG. 4, when the mouse 10 is placed on the work surface 150 and the mouse 10 is lifted in a direction away from the work surface 150 (y-axis direction perpendicular to the work surface), the image sensor of the mouse sensor 12 cannot receive reflected light of appropriate light intensity and cannot appropriately read the image of the work surface. In this case, the mouse sensor 12 outputs data indicating that the image of the work surface 150 cannot be read appropriately. Alternatively, the mouse sensor 12 may output data indicating a movement amount (a value greater than "0" when moving, "0" when stationary) when the mouse sensor 12 is on the work surface 150, while the mouse sensor 12 may output data indicating an error when the image of the work surface cannot be appropriately read. Alternatively, the mouse sensor 12 may output data indicating the intensity of reflected light or the like. The game apparatus 20 may determine that the mouse 10 is lifted, for example, by comparing the intensity of reflected light with a predetermined value. The game apparatus 20 can determine that the mouse 10 is lifted by receiving such data output when the mouse 10 is lifted. Here, an operation in which the bottom surface 101a of the mouse 10 provided with the mouse sensor 12 (opening 104) is moved in a direction away from the work surface 150 is called a "lifting operation."

### Overview of Game

Next, an example of a game performed using the mouse 10 will be described. A first game of this example embodiment is a goldfish scooping game.

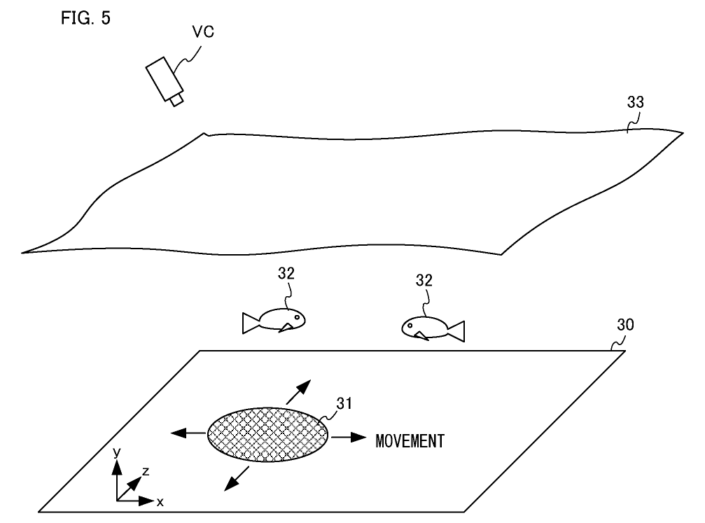

FIG. 5 is a diagram showing a state of a virtual space when the first game is performed in the game system 1.

When the game of this example embodiment is started, an xyz orthogonal coordinate system is set in a three-dimensional virtual space (game space). The y-axis is an upward axis of the virtual space, and the x-axis and z-axis are axes perpendicular to the y-axis.

As shown in FIG. 5, in the first game, a paper scooper object 31, a plurality of goldfish objects 32, and a water surface object 33 are arranged in the virtual space. The water surface object 33 is a substantially planar object and is an object imitating a water surface. Below the water surface object 33, the paper scooper object 31 and the plurality of goldfish objects 32 are arranged. Also, a virtual surface 30 is arranged below the water surface object 33 (for example, below the plurality of goldfish objects 32). Also, a virtual camera VC is arranged so as to look down on the paper scooper object 31, the plurality of goldfish objects 32, and the water surface object 33 from above. A game image of the virtual space viewed from the virtual camera VC is generated at predetermined frame time intervals (for example, 1/60 second intervals), and the game image is displayed on the display device 24 or an external display device.

The virtual surface 30 is a surface on which the paper scooper object 31 is arranged when the mouse 10 is on the work surface 150. For example, the virtual surface 30 is a surface parallel to the xz plane. The virtual surface 30 is not displayed on the screen of the display device. Note that the virtual surface 30 may be displayed on the screen. Also, the virtual surface 30 may be a curved surface, or may be a surface having a predetermined angle with respect to the xz plane.

The paper scooper object 31 is an example of a first object and is an object for scooping the goldfish object 32. The paper scooper object 31 moves along the virtual surface 30 according to the movement of the mouse 10 on the work surface 150. For example, when the mouse 10 is moved in the X-axis direction on the work surface 150, the paper scooper object 31 is moved in the x-axis direction of the virtual space on the virtual surface 30. Note that the paper scooper object 31 may be arranged at a position separated by a predetermined distance from the virtual surface 30 instead of being arranged on the virtual surface 30 when the mouse 10 is on the work surface 150. Even in this case, the paper scooper object 31 is moved along the virtual surface 30 while maintaining the distance from the virtual surface 30 according to the movement of the mouse 10 on the work surface 150.

The goldfish object 32 is an example of a second object and is an object imitating a goldfish. The goldfish object 32 is automatically moved by the processor 21 according to a predetermined algorithm. For example, the goldfish object 32 moves between the virtual surface 30 and the water surface object 33.

Note that, in FIG. 5, the paper scooper object 31 is arranged below the goldfish object 32, but the paper scooper object 31 and the goldfish object 32 may be arranged at the same height. In this case, when viewed from the virtual camera VC, if the paper scooper object 31 and the goldfish object 32 overlap, the goldfish object 32 may be displayed in front of the paper scooper object 31.

Also, the goldfish object 32 may be moved by a user operation. For example, a first user may control the paper scooper object 31 using a first mouse 10, and a second user may control movement of the goldfish object 32 using a second mouse 10. The second user may move the goldfish object 32 by moving the second mouse 10 on the work surface. Alternatively, one user may control movement of the paper scooper object 31 and the goldfish object 32.

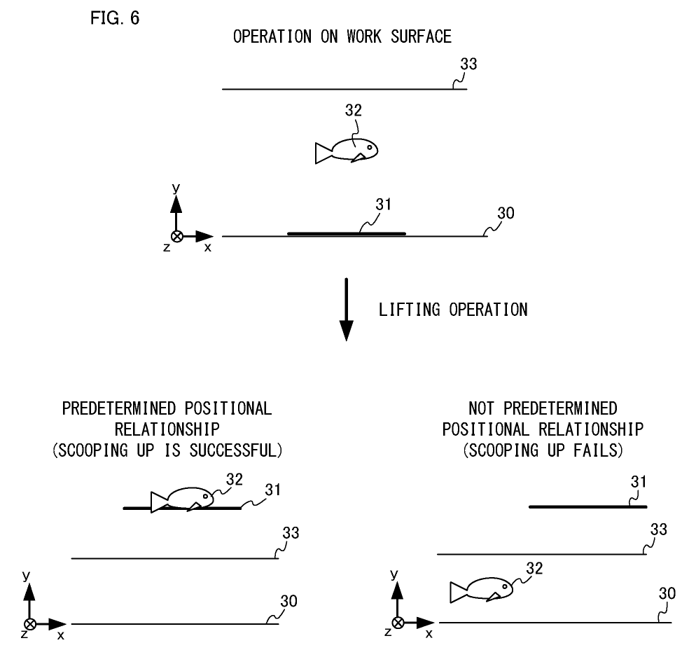

FIG. 6 is a diagram for explaining an operation of each object when a lifting operation is performed on the mouse 10 during execution of the first game. FIG. 6 shows a diagram of the paper scooper object 31 and the goldfish object 32 viewed from a direction parallel to the xz plane.

As shown in FIG. 6, by moving the mouse 10 on the work surface 150, the user moves the paper scooper object 31 along the virtual surface 30 so that the paper scooper object 31 is positioned below the goldfish object 32. In this state, when a lifting operation is performed on the mouse 10, the paper scooper object 31 moves in a direction away from the virtual surface 30.

Specifically, when a lifting operation is performed while the mouse 10 is operated on the work surface 150, the paper scooper object 31 moves in a normal direction (y-axis direction) of the virtual surface 30. When the lifting operation is performed on the mouse 10, if the paper scooper object 31 and the goldfish object 32 are in a predetermined positional relationship with respect to the virtual surface direction (for example, the normal direction of the virtual surface 30), scooping up of the goldfish object 32 is successful. Specifically, in a case where the goldfish object 32 and the paper scooper object 31 are in a positional relationship overlapping each other when viewed from above the virtual space, the paper scooper object 31 and the goldfish object 32 are moved above the water surface object 33 in a state where the goldfish object 32 is placed on the paper scooper object 31. That is, when the paper scooper object 31 and the goldfish object 32 are projected onto the virtual surface 30, if at least a part of the projected goldfish object 32 overlaps at least a part of the projected paper scooper object 31, the goldfish object 32 is scooped up.

On the other hand, when the lifting operation is performed on the mouse 10, if the paper scooper object 31 and the goldfish object 32 are not in the predetermined positional relationship with respect to the virtual surface direction, scooping up of the goldfish object 32 fails, and only the paper scooper object 31 moves above the water surface object 33.

When a lifting operation is performed on the mouse 10, regardless of an upward movement amount of the mouse 10 (called "lifting amount"), the paper scooper object 31 moves upward in the virtual space by a predetermined movement amount. If the paper scooper object 31 is moved upward by an amount according to the lifting amount of the mouse 10, and if a measurement error in the lifting amount of the mouse 10 occurs, there is a possibility that a timing when the mouse 10 is returned onto the work surface and a timing when the paper scooper object 31 returns onto the virtual surface 30 may shift, which may cause a sense of incongruity. For this reason, in this example embodiment, when the mouse 10 is lifted, the paper scooper object 31 is moved upward by a predetermined movement amount regardless of the lifting amount.

Note that the paper of the paper scooper object 31 may be torn and scooping up of the goldfish object 32 may fail according to a speed, acceleration, attitude (for example, angle with respect to a horizontal plane), angular velocity, or the like of the mouse 10 when the lifting operation is performed. For example, the speed, acceleration, angle, or the like of the mouse 10 at that time is calculated based on data from the inertial sensor 13 when the lifting operation is detected, and if the speed, acceleration, angle, or the like exceeds a threshold, the paper of the paper scooper object 31 may be torn.

After the mouse 10 is lifted and the paper scooper object 31 is separated from the virtual surface 30, when the mouse 10 is placed on the work surface 150 again, the paper scooper object 31 is returned onto the virtual surface 30.

Note that, in a state where the mouse 10 is lifted (a state where the paper scooper object 31 is separated from the virtual surface 30), if a predetermined condition is satisfied, the paper scooper object 31 may be returned onto the virtual surface 30 even in a state where the mouse 10 is lifted. For example, in a state where the paper scooper object 31 is separated from the virtual surface 30, if a predetermined operation (for example, pressing of the button 14, an operation of shaking the mouse 10, or the like) is performed on the mouse 10, the paper scooper object 31 may be returned onto the virtual surface 30. Also, in a state where the paper scooper object 31 is separated from the virtual surface 30, for example, the paper scooper object 31 may be returned onto the virtual surface 30 in response to a lapse of a predetermined time.

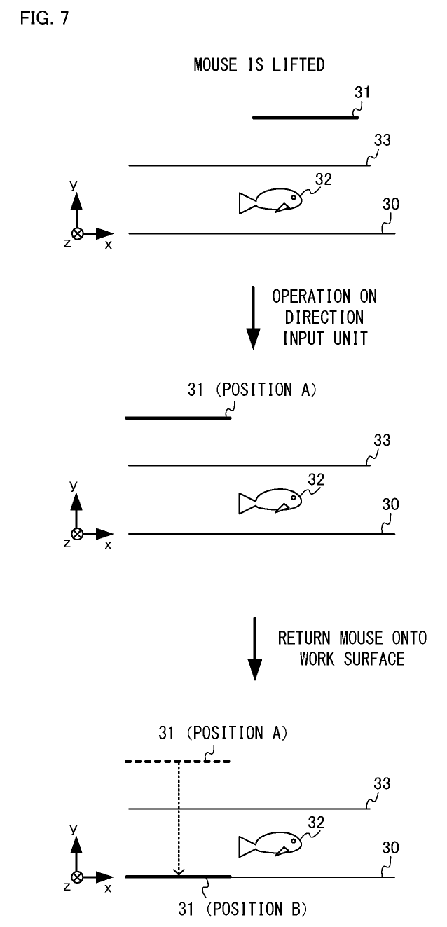

Also, in a state where the mouse 10 is lifted, for example, the paper scooper object 31 may be moved in response to an operation being performed on the direction input unit 16. FIG. 7 is a diagram showing a state in which the paper scooper object 31 moves in response to an operation being performed on the direction input unit 16 in a state where the mouse 10 is lifted.

As shown in FIG. 7, in a state where the mouse 10 is lifted (a state where the paper scooper object 31 is separated from the virtual surface 30), when an operation is performed on the direction input unit 16, the paper scooper object 31 is moved in the state separated from the virtual surface 30. For example, the paper scooper object 31 is moved in a direction of the virtual space according to an input direction of the direction input unit 16 while maintaining the distance from the virtual surface 30. Note that when the mouse 10 is on the work surface 150, the paper scooper object 31 is not moved even if an operation is performed on the direction input unit 16.

Also, as shown in FIG. 7, when the mouse 10 is placed on the work surface 150 again after the paper scooper object 31 is moved according to the operation on the direction input unit 16, the paper scooper object 31 is returned to a position B along the virtual surface 30 (for example, a position on the virtual surface) corresponding to a position A after the movement according to the operation on the direction input unit 16. For example, when the mouse 10 is placed on the work surface 150 again, the paper scooper object 31 is moved to the coordinates of a foot of a perpendicular line dropped onto the virtual surface 30 from coordinates of the paper scooper object 31 after the movement according to the operation on the direction input unit 16

Also, in a state where the mouse 10 is lifted, the attitude of the paper scooper object 31 may be controlled according to the attitude of the mouse 10. For example, when the mouse 10 is lifted and the goldfish object 32 is scooped up, the goldfish object 32 moves on the paper scooper object 31 and tries to go out of a frame of the paper scooper object 31. In this case, the user tilts the mouse 10 so that the goldfish object 32 does not go out of the frame of the paper scooper object 31. The paper scooper object 31 tilts according to the tilt of the mouse 10, and the goldfish object 32 on the paper scooper object 31 moves in a direction along the tilt of the paper scooper object 31. Thereby, the user can keep the goldfish object 32 on the paper scooper object 31.

Also, a bucket is arranged in the virtual space, and by tilting the mouse 10 greatly in a state where the mouse 10 is lifted, the paper scooper object 31 tilts greatly, and the goldfish object 32 on the paper scooper object 31 can be dropped into the bucket.

As described above, in the first game, the paper scooper object 31 moves along the virtual surface 30 according to the movement of the mouse 10 on the work surface 150. When the mouse 10 is lifted from the work surface, the paper scooper object 31 moves in the direction away from the virtual surface. Regardless of the lifting amount of the mouse 10, the paper scooper object 31 moves in the direction away from the virtual surface by a predetermined movement amount. When the paper scooper object 31 and the goldfish object 32 are in the predetermined positional relationship with respect to the virtual surface direction while the mouse 10 is lifted from the work surface, the goldfish object 32 is scooped up. Thereby, a game can be played by an intuitive operation using the mouse 10.

Also, when the mouse 10 is tilted while the mouse 10 is lifted from the work surface, the paper scooper object 31 tilts. Thereby, the scooped goldfish object 32 can be kept on the paper scooper object 31.

Also, the paper scooper object 31 can be moved according to the operation on the direction input unit 16 when the mouse 10 is lifted from the work surface.

### Details of Game Processing

Next, details of game processing performed in the game system 1 will be described. Hereinafter, game processing when the first game is performed will be described as an example of a game of this example embodiment. First, data used for game processing will be described.

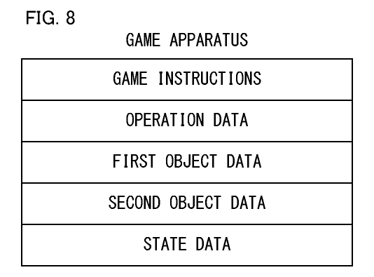

FIG. 8 is a diagram showing an example of various data used for game processing related to the first game. As shown in FIG. 8, game instructions, operation data, first object data, second object data, and state data are stored in a memory (for example, the DRAM 22, the storage medium 23, or the like) of the game system 1.

The game instructions are instructions for executing game processing related to a game. The game instructions are stored in the storage medium 23 in advance, and are read from the storage medium 23 and stored in the DRAM 22 when a game is executed.

The operation data is data regarding operations performed on the mouse 10. The operation data is transmitted from the mouse 10 to the game apparatus 20 at predetermined time intervals (for example, 1/200 second intervals). The operation data transmitted from the mouse 10 is stored in the memory. Specifically, the operation data includes data regarding a movement direction and a movement amount calculated based on data from the mouse sensor 12. Note that, in the mouse 10, when a position is calculated in addition to the movement direction and movement amount, the operation data includes data regarding the calculated position. Also, when the mouse sensor 12 cannot appropriately read the image of the work surface, the operation data includes data indicating that the image of the work surface could not be appropriately read. Also, the operation data includes data regarding movement and attitude of the mouse 10 calculated based on data from the inertial sensor 13. Also, the operation data includes data indicating whether or not the button 14 is pressed and data regarding an operation on the direction input unit 16.

The first object data includes data regarding a position and attitude of a first object. Also, the first object data includes data indicating an appearance such as shape data and texture data of the first object. An example of the first object is the paper scooper object 31.

The second object data includes data regarding a position and attitude of a second object. Also, the second object data includes data indicating an appearance such as shape data and texture data of the second object. An example of the second object is the goldfish object 32.

The state data is data regarding a state of the mouse 10. Specifically, the state data is data indicating whether the mouse 10 is on the work surface or is lifted.

Note that, in addition to these, various data such as data regarding a game (for example, data regarding the number of scooped goldfish objects 32) are stored in the memory.

### Game Processing

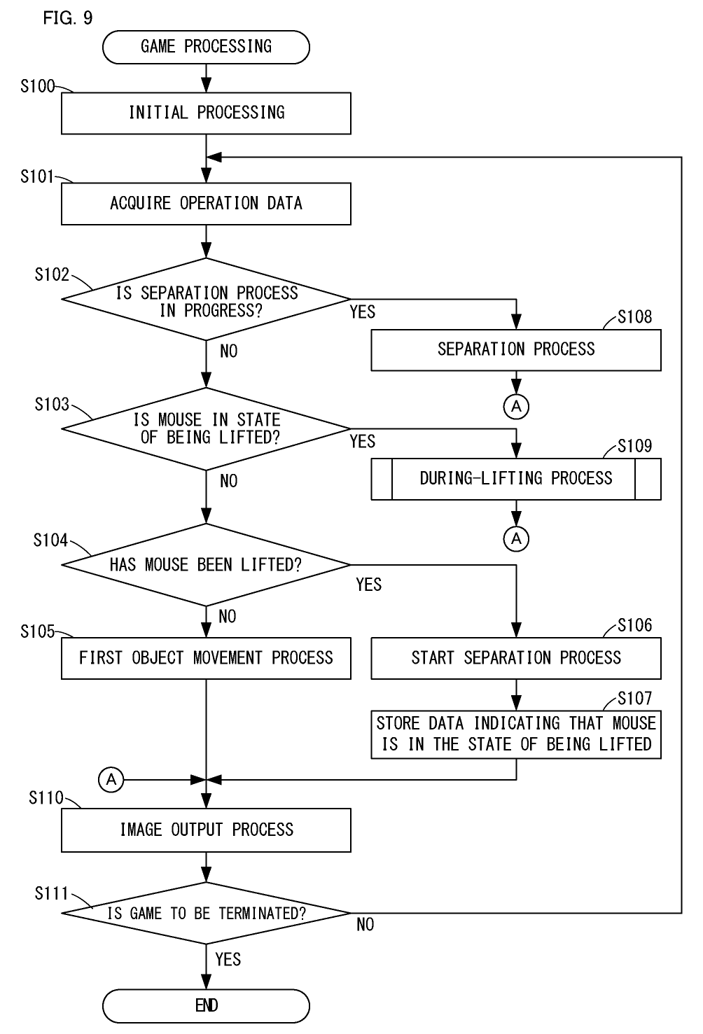

Next, game processing related to the first game will be described. FIG. 9 is a flowchart showing an example of game processing related to the first game.

Hereinafter, description will be made assuming that the processor 21 of the game apparatus 20 executes each step of the processing shown in FIG. 9 by executing the game instructions using the memory (for example, the DRAM 22). Note that some of the steps of the processing may be executed by a processor (for example, a dedicated circuit or the like) different from the processor 21. Also, if the game system 1 can communicate with another information processing apparatus (for example, a server), some of the steps of the processing may be executed in the other information processing apparatus.

As shown in FIG. 9, in step S100, the processor 21 executes initial processing. Specifically, the processor 21 arranges the virtual surface 30 and the water surface object 33 in the virtual space. Also, the processor 21 arranges the paper scooper object 31 as an example of a first object, and arranges a plurality of goldfish objects 32 as an example of a second object.

Next, the processor 21 acquires operation data (step S101). The game apparatus 20 repeatedly acquires operation data from the mouse 10 at predetermined time intervals (for example, 1/200 second intervals) and stores it in the memory. The processor 21 acquires the operation data stored in the memory in step S101. Thereafter, the processor 21 repeatedly executes the processing of steps S101 to S111 at predetermined frame time intervals (for example, 1/60 second intervals).

Next, the processor 21 determines whether or not a separation process is in progress (step S102). The separation process is a process for separating the first object from the virtual surface, and is started in step S106 described later. Here, it is determined whether or not the separation process started in step S106 is being executed.

If it is determined that the separation process is not in progress (step S102: NO), the processor 21 determines whether or not the mouse 10 is in a state of being lifted based on the state data (step S103).

If it is determined that the mouse 10 is not in the state of being lifted (step S103: NO), the processor 21 determines whether or not the mouse 10 has been lifted based on the operation data (step S104). For example, if the acquired operation data includes data indicating that the image of the work surface could not be appropriately read, the processor 21 determines that the mouse 10 has been lifted in the current frame.

If it is not determined that the mouse 10 has been lifted in the current frame (step S104: NO), the processor 21 performs a first object movement process (step S105). Here, a process of moving the first object on the virtual surface according to the movement of the mouse 10 on the work surface is performed. Specifically, the processor 21 updates a position of the paper scooper object 31 on the virtual surface 30 based on a current position of the paper scooper object 31 and data regarding the movement direction and movement amount included in the acquired operation data, and stores it as the first object data. Note that, when the game apparatus 20 receives data indicating a position from the mouse 10, the processor 21 updates the position of the paper scooper object 31 based on the received data indicating the position.

On the other hand, if it is determined that the mouse 10 has been lifted in the current frame (step S104: YES), the processor 21 starts the separation process of the first object (step S106). Specifically, the processor 21 starts moving the paper scooper object 31 in a direction away from the virtual surface 30. Note that the processor 21 may start the separation process of the first object when the mouse 10 is lifted and a predetermined operation (for example, an operation of pressing the button 14a) is performed.

Next, the processor 21 stores data indicating that the mouse 10 is in the state of being lifted in the state data (step S107).

On the other hand, if it is determined that the separation process is in progress (step S102: YES), the processor 21 performs the separation process (step S108). Here, the processor 21 moves the paper scooper object 31 so that the paper scooper object 31 is separated from the virtual surface 30 by a predetermined distance. Specifically, in the separation process, the processor 21 moves the paper scooper object 31 in the y-axis direction by a movement amount for one frame until a distance between the paper scooper object 31 and the virtual surface 30 reaches a predetermined value. The position of the paper scooper object 31 after movement is stored as the first object data. Also, when the paper scooper object 31 hits a goldfish object 32 during the separation process, the processor 21 moves the goldfish object 32 in the y-axis direction together with the paper scooper object 31. By repeatedly performing the separation process of step S108 for several to several tens of frames, a state in which the paper scooper object 31 moves to a predetermined position is displayed, and if the goldfish object 32 is hit during the movement of the paper scooper object 31, the goldfish object 32 is scooped up.

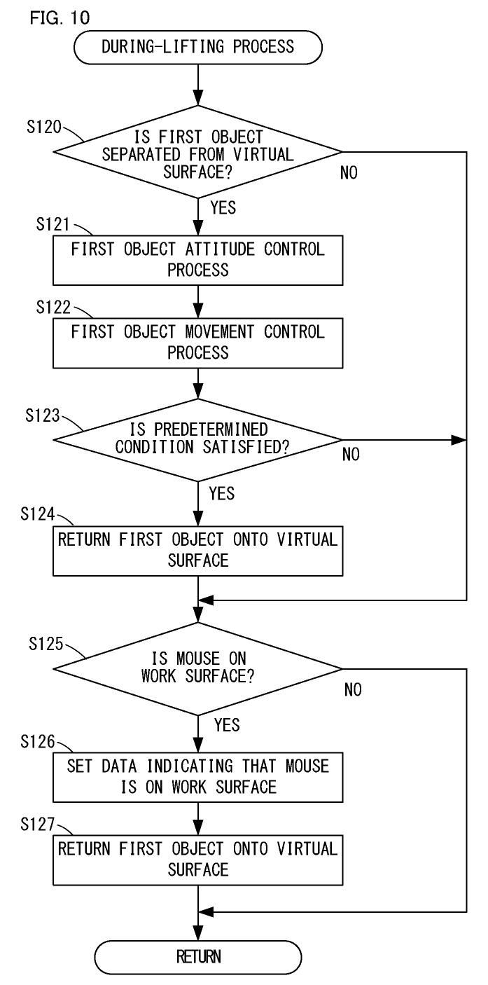

On the other hand, if it is determined that the mouse 10 is in the state of being lifted (step S103: YES), the processor 21 performs a during-lifting process (step S109). Hereinafter, details of the during-lifting process of step S109 will be described with reference to FIG. 10. FIG. 10 is a flowchart showing an example of the during-lifting process of step S107.

As shown in FIG. 10, first, the processor 21 determines whether or not the first object is separated from the virtual surface (step S120). Here, after the first object is separated from the virtual surface 30 by the separation process, it is determined whether or not the separated state continues. Specifically, the processor 21 refers to the first object data and determines whether or not the paper scooper object 31 is separated from the virtual surface 30 by a predetermined distance.

If it is determined that the first object is separated from the virtual surface (step S120: YES), the processor 21 performs a first object attitude control process (step S121). Here, the processor 21 controls the attitude of the paper scooper object 31 based on the attitude data of the mouse 10 included in the operation data.

Next, the processor 21 performs a first object movement control process (step S122). Here, the processor 21 determines whether or not an operation on the direction input unit 16 of the mouse 10 has been performed based on the operation data, and if the operation on the direction input unit 16 has been performed, moves the paper scooper object 31 in the virtual space according to the input direction. If the operation on the direction input unit 16 has not been performed, the processor 21 does not move the paper scooper object 31.

Next, the processor 21 determines whether or not a predetermined condition is satisfied (step S123). The predetermined condition may be, for example, that a predetermined operation (for example, a button 14 pressing operation, an operation of shaking the mouse 10, or the like) has been performed on the mouse 10. Also, the predetermined condition may be that a predetermined time has elapsed since the first object was separated from the virtual surface by the predetermined distance.

If the predetermined condition is satisfied (step S123: YES), the processor 21 returns the first object onto the virtual surface (step S124). Specifically, while maintaining a current x-axis coordinate value and z-axis coordinate value of the paper scooper object 31, the processor 21 sets a y-axis coordinate value to the same value as the y-axis coordinate value of the virtual surface 30 over a plurality of frame times. Thereby, the paper scooper object 31 moves downward and is arranged on the virtual surface 30 again over a predetermined time.

When the processing of step S124 is performed, when NO is determined in step S120, or when NO is determined in step S123, the processor 21 determines whether or not the mouse 10 is on the work surface (step S125). Here, it is determined whether or not the lifted mouse 10 is placed on the work surface again. For example, if the operation data includes data indicating a movement direction and a movement amount of the mouse 10, the processor 21 determines that the mouse 10 is on the work surface.

If it is determined that the mouse 10 is on the work surface (step S125: YES), the processor 21 stores data indicating that the mouse 10 is on the work surface in the state data (step S126).

Next, the processor 21 returns the first object onto the virtual surface (step S127). Specifically, while maintaining the current x-axis coordinate value and z-axis coordinate value of the paper scooper object 31, the processor 21 sets the y-axis coordinate value to the same value as the y-axis coordinate value of the virtual surface 30.

When the processing of step S127 is performed, or when NO is determined in step S125, the processor 21 ends the processing shown in FIG. 10 and returns the processing to FIG. 9.

Returning to FIG. 9, when the processing of step S107, step S108, or step S109 is performed, the processor 21 performs an image output process (step S110). Here, the processor 21 generates an image of the virtual space based on the virtual camera set in the virtual space, and displays the generated image on the display device.

Next, the processor 21 determines whether or not to end the game (step S111). For example, when an end of the game is instructed by the user or when a predetermined time has elapsed since a start of the game, the processor 21 determines to end the game. If it is determined not to end the game (step S111: NO), the processor 21 executes the processing of step S101 again.

Note that the processing of each step shown in FIG. 9 is merely an example, and the processing order of each step may be changed, or another process may be executed in addition to (or instead of) the processing of each step as long as a similar result is obtained.

### Modifications

The game of this example embodiment has been described above, but the above example embodiment is merely an example, and for example, the following modifications may be added.

For example, the mouse 10 may be configured to be usable in a manner like a game controller operated while being lifted with one or both hands by the user. Note that the mouse 10 may be configured to be able to switch ON/OFF of a mouse function. For example, when the user desires to operate the mouse 10 exclusively by lifting it without using it on the work surface, the mouse function may be configured to be able to be turned OFF. The mouse 10 may include, in addition to the mouse sensor 12, one or more push buttons, one or more cross keys, one or more analog sticks, and an inertial sensor 13 for the user to perform a game operation. The mouse 10 may be detachably connected to the game apparatus 20. In this case, the mouse 10 and the game apparatus 20 may be connected such that a surface on which the mouse sensor 12 (opening 104) is provided and a side surface of the game apparatus 20 face each other.

Also, in the above example embodiment, a goldfish scooping game is performed as the first game using the mouse 10, but another game may be performed. Hereinafter, an example of another game performed in the game system 1 will be described.

### Second Game

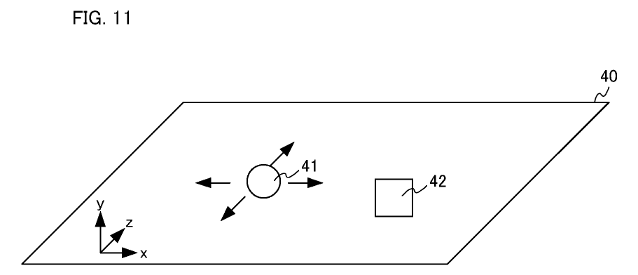

Next, a second game using the mouse 10 will be described. FIG. 11 is a diagram showing each object arranged in the virtual space when the second game is performed. As shown in FIG. 11, in the second game, a virtual surface 40 is arranged in the virtual space. On the virtual surface 40, a user object 41 corresponding to a user and an enemy object 42 are arranged. Also, a virtual camera not shown is arranged in the virtual space.

The user object 41 is an example of a first object and moves on the virtual surface 40 according to the movement of the mouse 10 on the work surface 150. The virtual surface 40 may be, for example, a ground.

The enemy object 42 (an example of a third object) moves on the virtual surface 40. The enemy object 42 is automatically controlled by the processor 21 according to a predetermined algorithm. For example, the enemy object 42 moves so as to approach the user object 41. Note that the enemy object 42 may be moved on the virtual surface 40 by a user operation.

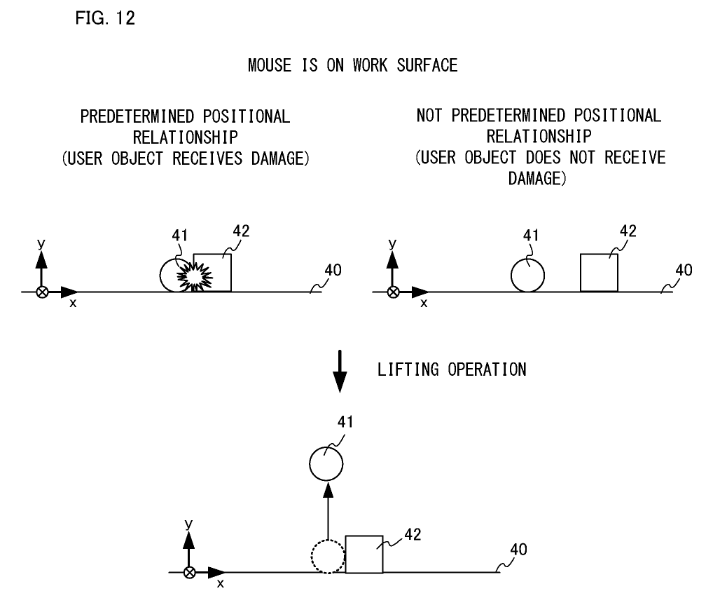

FIG. 12 is a diagram for explaining an operation of each object when a lifting operation is performed on the mouse 10 during execution of the second game.

As shown in FIG. 12, when the mouse 10 is on the work surface 150, the user object 41 moves on the virtual surface 40. When the mouse 10 is on the work surface 150, if the user object 41 and the enemy object 42 are in a predetermined positional relationship, the user object 41 receives damage. For example, when the user object 41 hits the enemy object 42, the user object 41 receives damage. When the mouse 10 is on the work surface 150, if the user object 41 and the enemy object 42 are not in the predetermined positional relationship, the user object 41 does not receive damage.

On the other hand, when a lifting operation is performed on the mouse 10, the user object 41 moves in a direction away from the virtual surface 40. For example, the user object 41 may move in a direction perpendicular to the virtual surface 40, or may move in an obliquely upward direction with respect to the virtual surface 40. When the user object 41 is separated from the virtual surface 40, the user object 41 does not receive damage from the enemy object 42. After the user object 41 is separated from the virtual surface 40, if a predetermined condition is satisfied, the user object 41 returns onto the virtual surface 40. For example, when a predetermined time elapses after the user object 41 is separated from the virtual surface 40, the user object 41 returns onto the virtual surface 40. The user prevents the user object 41 from hitting the enemy object 42 by moving the mouse 10 on the work surface 150 or performing a lifting operation.

As described above, in the second game, the user object 41 moves along the virtual surface 40 according to the movement of the mouse 10 on the work surface 150. When the mouse 10 is on the work surface 150, damage is added to the user object 41 when the user object 41 and the enemy object 42 are in a predetermined positional relationship. When the mouse 10 is lifted from the work surface 150, the user object 41 moves in the direction away from the virtual surface 40, and the user object 41 ceases to receive damage from the enemy object 42. Thereby, a novel game can be performed by an intuitive and simple operation using the mouse 10.

### Third Game

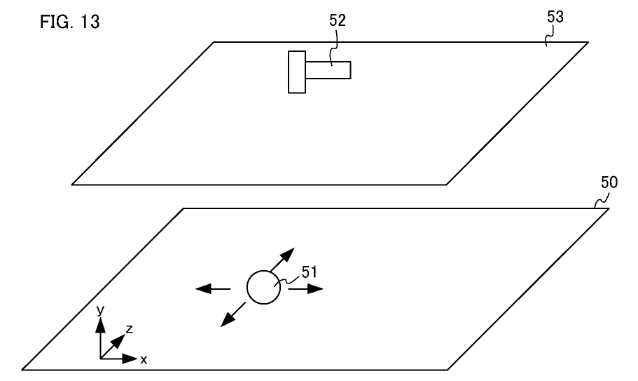

Next, a third game using the mouse 10 will be described. FIG. 13 is a diagram showing each object arranged in the virtual space when the third game is performed. As shown in FIG. 13, in the third game, a virtual surface 50 is arranged in the virtual space. A user object 51 corresponding to a user is arranged on the virtual surface 50. Also, a virtual camera not shown is arranged in the virtual space.

The user object 51 is an example of a first object and moves on the virtual surface 50 according to the movement of the mouse 10 on the work surface 150. The virtual surface 50 is, for example, a surface in the ground.

Also, a second surface 53 is arranged in the virtual space. The second surface 53 is arranged at a position higher than the virtual surface 50 and is, for example, a ground. A hammer object 52 is arranged above the second surface 53. The hammer object 52 (an example of a fourth object) is automatically controlled by the processor 21 according to a predetermined algorithm. Note that the hammer object 52 may be moved along the second surface 53 by a user operation.

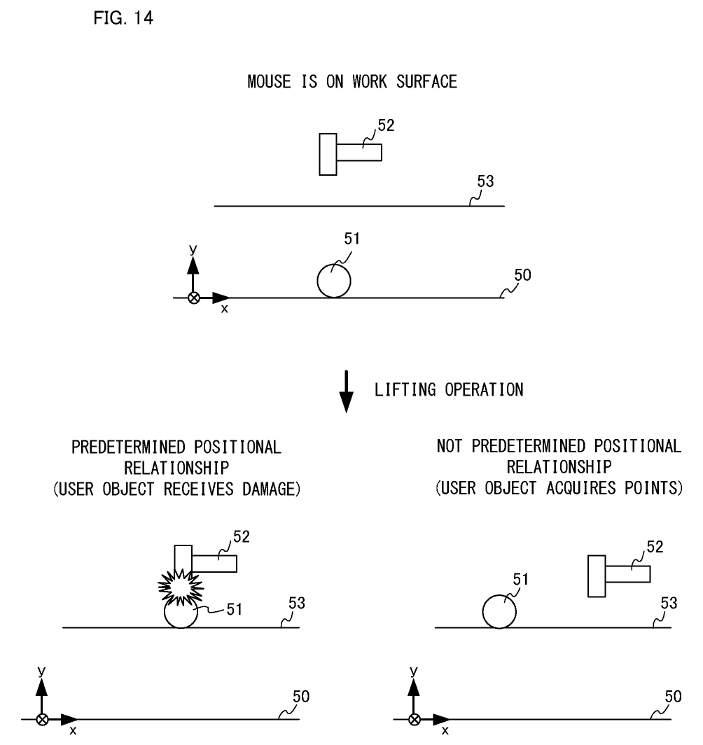

FIG. 14 is a diagram for explaining an operation of each object when a lifting operation is performed on the mouse 10 during execution of the third game.

When the mouse 10 is on the work surface 150, the user object 51 moves on the virtual surface 50. As shown in FIG. 14, when a lifting operation is performed on the mouse 10, the user object 51 moves away from the virtual surface 50 and onto the second surface 53. When the user object 51 moved onto the second surface 53 and the hammer object 52 are in a predetermined positional relationship, the user object 51 receives damage. For example, if a distance between the user object 51 moved onto the second surface 53 and the hammer object 52 is within a predetermined range, the user object 51 receives damage. On the other hand, if the distance between the user object 51 moved onto the second surface 53 and the hammer object 52 is outside the predetermined range, the user object 51 does not receive damage and acquires points. A result of the third game is determined based on the damage received by the user object 51 and the points acquired by the user object 51 during a predetermined time. The user can acquire points by moving the mouse 10 on the work surface 150 and lifting the mouse 10 at a position where the hammer object 52 does not exist in the y-axis direction.

As described above, in the third game, the user object 51 moves along the virtual surface 50 according to the movement of the mouse 10 on the work surface 150. When the mouse 10 is lifted from the work surface 150, the user object 51 moves in the direction away from the virtual surface 50 and moves onto the second surface 53. When the user object 51 moved onto the second surface 53 and the hammer object 52 are in a predetermined positional relationship, the user object 51 receives damage, and when they are not in the predetermined positional relationship, the user object 51 acquires points. Thereby, a novel game can be performed by an intuitive and simple operation using the mouse 10.

### Fourth Game

Also, in a fourth game, a game like figure skating may be performed using the mouse 10. In the fourth game, a character and a virtual surface (a surface imitating a skating rink) are arranged in the virtual space. By moving the mouse 10 on the work surface 150, the character as an example of a first object slides on the virtual surface. A movement direction and movement speed of the character on the virtual surface are determined according to the movement of the mouse on the work surface. When a lifting operation is performed on the mouse 10 while the character is moving on the virtual surface, the character jumps and moves away from the virtual surface. Virtual gravity directed downward in the virtual space is applied to the character, and the jumped character falls onto the virtual surface after a predetermined time. A trajectory during jumping of the character is determined according to the movement direction and movement speed when the character jumps. Also, a height of the jump may be determined according to a speed of lifting the mouse 10 or an acceleration applied to the mouse 10 when lifting. Also, a direction of the jump may be determined according to a direction of lifting the mouse 10. Also, when the character is jumping, the character may spin or move hands or feet according to an operation on the button 14 or the direction input unit 16. Also, an attitude of the character during jumping may be determined according to the attitude of the mouse 10 when the mouse 10 is lifted. Points may be calculated based on these actions of the character during jumping (for example, spin, spreading hands and feet, attitude) or the like.

### Fifth Game

Also, a fifth game is a game in which an airplane object is operated using the mouse 10. In the fifth game, a ground and an airplane object are arranged in the virtual space. By moving the mouse 10 on the work surface 150, the airplane object as an example of a first object moves or accelerates on the ground. By lifting the mouse 10, the airplane object takes off. Whether or not taking-off of the airplane object is successful may be determined according to a state when the mouse 10 is lifted. For example, when the mouse 10 is lifted while the mouse 10 is moving on the work surface 150 at a predetermined speed, the airplane object takes off normally. Also, whether or not the airplane object normally takes off may be determined according to the speed of lifting the mouse 10, the acceleration applied to the mouse 10 when lifting, the attitude of the mouse 10 when lifting, or the like. The attitude of the airplane object after taking-off is controlled according to the attitude of the mouse 10 when the mouse 10 is lifted. For example, when the mouse 10 is tilted upward (that is, when the Z-axis is tilted obliquely upward), the nose of the airplane object may rise and an altitude may increase. Also, when the mouse 10 is rotated in a roll direction (that is, when it is rotated around the Z-axis), the airplane object may rotate in the roll direction and turn. Also, a position of the airplane object on the screen may be controlled according to an operation on the direction input unit 16. Also, a bullet may be fired from the airplane object according to an operation on the button 14 to attack an enemy aircraft. Also, the airplane object may be landed by returning the mouse 10 onto the work surface. Also, when the mouse 10 is tilted downward while the mouse 10 is lifted (that is, when the Z-axis is tilted obliquely downward), the airplane object may be landed regardless of whether or not the mouse 10 is lifted. Also, landing of the airplane object may be successful by slowly returning the mouse 10 onto the work surface while tilting the mouse 10 downward in a state where the mouse 10 is lifted. In this case, whether or not the landing of the airplane object is successful may be determined by a timing when the airplane object lands and a timing when the mouse 10 returns onto the work surface. For example, if the mouse 10 is not returned to the work surface at the timing when the airplane object lands, the landing may fail. Also, the airplane object has fuel, and if the fuel runs out in the air, the airplane object may crash and return to the ground even if the mouse 10 is lifted. Also, if the airplane object receives an attack from an enemy aircraft, the airplane object may crash and return to the ground according to the damage even if the mouse 10 is lifted.

### Sixth Game

Also, a sixth game is a game in which a character performs track and field events such as a long jump on a field. In the sixth game, a ground and a character are arranged in the virtual space. By moving the mouse 10 on the work surface 150, the character as an example of a first object runs on the ground. For example, the character performs a long jump. When the mouse 10 is quickly reciprocated in a predetermined direction so as to rub the work surface, a speed of the character increases. By lifting the mouse 10 at a timing when the speed of the character increases, the character jumps. Virtual gravity directed downward in the virtual space is applied to the character, and the character falls to the ground when a predetermined time has elapsed. A flight distance of the character is determined by the speed of the character and a timing of the jump. Also, a speed or acceleration when the mouse 10 is lifted may affect the flight distance of the character. Also, when the mouse 10 is shaken or an operation on the direction input unit 16 is performed when the mouse 10 is lifted, the character performs an aerial action during jumping. The flight distance of the jump may be extended by this aerial action.

As described above, a first object is moved along a virtual surface based on first data output when the mouse 10 is on the work surface 150. The first data may be, for example, data regarding a movement direction and a movement amount output when the mouse 10 moves on the work surface. Also, the first data may or may not include data regarding operations on the button 14 and the direction input unit 16. Also, the first data may or may not include data regarding the inertial sensor 13. The first object may be, for example, the paper scooper object 31 described above, the user object 41 or the like, or any other object.

Also, the first object is moved in a direction away from the virtual surface based on second data output when the mouse 10 is lifted from the work surface 150. The second data is data indicating that the mouse 10 is not on the work surface, and may be, for example, data indicating that the mouse sensor 12 cannot appropriately read the image of the work surface as described above, or data indicating the above error.

Also, the second data may be based on data from the inertial sensor 13, for example, instead of being based on data from the mouse sensor 12. Movement and attitude of the mouse 10 are calculated based on data from the inertial sensor 13. When the mouse 10 is on the work surface 150, the mouse 10 may rotate around the Z-axis, but does not rotate around the X-axis or the Y-axis. On the other hand, when the mouse 10 is not on the work surface 150, the mouse 10 may rotate around the X-axis or the Y-axis. For this reason, for example, when data indicating that the mouse 10 has rotated around the X-axis or the Y-axis is received as the second data, the game apparatus 20 may move the first object in a direction away from the virtual surface.

Also, the mouse 10 includes, for example, a sensor (for example, a distance measuring sensor) that measures a distance from the work surface 150, and the second data may be data from the distance measuring sensor. A height of the mouse 10 from the work surface 150 is calculated based on the second data from the distance measuring sensor, and when the calculated height exceeds a threshold, it may be determined that the mouse 10 is lifted.

Also, an operation different from the lifting operation of the mouse 10 described above, in which the mouse 10 is tilted with respect to the work surface 150 in a state where a part of the mouse 10 is in contact with the work surface 150 (called an "inclining operation" here), may be performed. In this case, a separation process of separating the first object from the virtual surface may be performed by the lifting operation of the mouse 10, and another process may be performed by the inclining operation of the mouse 10.

For example, based on an image acquired by the mouse sensor 12 and data from the inertial sensor 13, it can be determined whether or not the mouse 10 is on the work surface 150, whether or not a lifting operation has been performed, and whether or not an inclining operation has been performed. For example, when the mouse sensor 12 can appropriately read the image of the work surface (for example, when the light intensity of the image exceeds a first value), it can be determined that the mouse 10 is on the work surface 150. Also, when the mouse sensor 12 cannot appropriately read the image of the work surface (for example, when the light intensity is less than a second value), it can be determined that a lifting operation has been performed on the mouse 10. Also, when the mouse sensor 12 can read an image but the light intensity is in a predetermined range (for example, a range greater than the second value and smaller than the first value) and it is determined that the mouse 10 is rotating around the X-axis or the Y-axis based on data from the inertial sensor 13, it can be determined that an inclining operation has been performed on the mouse 10. Alternatively, when the mouse 10 includes a plurality of mouse sensors 12, if one mouse sensor 12 can appropriately read the image of the work surface and the other mouse sensor 12 cannot appropriately read the image of the work surface, it can be determined that an inclining operation has been performed on the mouse 10.

Also, game processing may be performed using a plurality of mice including mouse sensors 12. For example, game processing may be performed using the mouse 10 and a second mouse including a mouse sensor 12. The second mouse may have a shape similar to that of the mouse 10, and may have a button 14 and a direction input unit 16 on the right side surface 102b. In this case, the user performs a game operation by holding the mouse 10 with the right hand, holding the second mouse with the left hand, moving the mouse 10 and the second mouse on the work surface, or operating the button 14 and the direction input unit 16. For example, in the fourth game as described above, by alternately moving the mouse 10 and the second mouse on the work surface, left and right feet of the character may be alternately moved, and the character may be moved on the virtual surface. For example, by alternately moving the mouse 10 and the second mouse on the work surface with good timing, both feet of the character move alternately with good timing, and the speed of the character may increase. Also, by lifting both the mouse 10 and the second mouse, the character may jump using both feet. A height or distance of a jump may differ according to a degree of coincidence between a timing when the mouse 10 is lifted and a timing when the second mouse is lifted, and a rotation speed or action of the character during jumping, an action when the character lands, or the like may differ. Also, by lifting one of the mouse 10 and the second mouse, the character may jump using one foot. Also, game processing may be performed by a plurality of mice including mouse sensors 12 communicating with each other.

Also, part or all of the processing performed by the game apparatus 20 described above may be configured to be performed by the mouse 10. Also, part or all of the processing performed by the mouse 10 may be configured to be performed by the game apparatus 20. For example, the mouse 10 may transmit an image from the mouse sensor 12 to the game apparatus 20, and the game apparatus 20 may calculate movement of the mouse 10 on the work surface 150 based on the image acquired from the mouse 10. Also, the game apparatus 20 may determine whether or not the mouse 10 has been lifted based on the acquired image. Also, the mouse 10 may transmit data from the inertial sensor 13 to the game apparatus 20, and the game apparatus 20 may calculate movement and attitude of the mouse 10 based on the data. Then, the game apparatus 20 may determine whether or not the mouse 10 has been lifted based on the calculated movement and attitude.

Also, the game processing described above is not limited to the game system 1, and may be executed in any other information processing apparatus or information processing system. The information processing system may be composed of a plurality of apparatuses, and the plurality of apparatuses may be connected via a network (for example, a LAN, the Internet, or the like). Also, the processing described above may be distributed and executed by each of a plurality of apparatuses.

Also, configurations according to the above example embodiments and modifications thereof can be arbitrarily combined as long as they do not contradict each other. Also, the above is merely an illustration of an exemplary embodiment, and various improvements and modifications other than the above may be added.

What is claimed is:

1. One or more non-transitory computer-readable storage media having stored therein instructions that, when executed, cause one or more processors to perform operations comprising:
moving a first object along a virtual surface in a virtual space based on first data output in response to movement of a mouse on a work surface; and
performing a separation process of moving the first object in a direction away from the virtual surface based on second data output in response to the mouse being lifted from the work surface.

2. The one or more non-transitory computer-readable storage media according to claim 1, wherein
in the separation process, regardless of an amount that the mouse is lifted from the work surface, the first object is separated from the virtual surface by a predetermined movement amount.

3. The one or more non-transitory computer-readable storage media according to claim 1, wherein
when a condition is satisfied in a state where the first object is separated from the virtual surface, the first object is returned to a position along the virtual surface even when the mouse is lifted from the work surface.

4. The one or more non-transitory computer-readable storage media according to claim 1, wherein the operations further comprise:
generating an image looking down on the virtual surface from above the virtual space based on a virtual camera; and
when the mouse is lifted from the work surface, in the separation process, moving the first object in a direction away from the virtual surface toward the virtual camera.

5. The one or more non-transitory computer-readable storage media according to claim 1, wherein
the mouse includes a direction input unit, and
when the mouse is lifted from the work surface and the first object is separated from the virtual surface, the first object is moved according to an input on the direction input unit.

6. The one or more non-transitory computer-readable storage media according to claim 5, wherein
when the mouse is on the work surface, the first object is not moved according to the input on the direction input unit.

7. The one or more non-transitory computer-readable storage media according to claim 5, wherein
when the mouse is returned onto the work surface after the first object is moved according to the input on the direction input unit while the first object is separated from the virtual surface, the first object is arranged at a position along the virtual surface according to a position after being moved according to the input on the direction input unit.

8. The one or more non-transitory computer-readable storage media according to claim 1, wherein the operations further comprise:
controlling an attitude of the first object according to an attitude of the mouse when the mouse is lifted from the work surface.

9. The one or more non-transitory computer-readable storage media according to claim 1, wherein the operations further comprise:
moving a second object based on a user input or a predetermined algorithm; and
executing a first process if the mouse is lifted from the work surface when the first object and the second object are in a first positional relationship with respect to a virtual surface direction.

10. The one or more non-transitory computer-readable storage media according to claim 9, wherein the operations further comprise:
when the mouse is lifted from the work surface, controlling the attitude of the first object according to the attitude of the mouse, and executing a second process regarding the second object that was in the first positional relationship.

11. The one or more non-transitory computer-readable storage media according to claim 1, wherein the operations further comprise:
moving a third object along the virtual surface based on a user input or a predetermined algorithm; and
executing a third process if the first object and the third object are in a second positional relationship when the mouse is on the work surface, and not executing the third process when the mouse is lifted from the work surface.

12. The one or more non-transitory computer-readable storage media according to claim 1, wherein the operations further comprise:
moving a fourth object based on a user input or a predetermined algorithm; and
executing a fourth process if the first object moved in the direction away from the virtual surface and the fourth object are in a third positional relationship.

13. The one or more non-transitory computer-readable storage media according to claim 1, wherein the mouse includes a first mouse and a second mouse, and the operations further comprise:
moving the first object along the virtual surface according to movement of the first mouse and the second mouse on the work surface; and
moving the first object in the direction away from the virtual surface in response to the first mouse and the second mouse being lifted from the work surface.

14. A game system comprising:
one or more processors; and
memory storing instructions that, when executed, cause the one or more processors to perform operations comprising:
moving a first object along a virtual surface in a virtual space based on first data output in response to movement of a mouse on a work surface; and
performing a separation process of moving the first object in a direction away from the virtual surface based on second data output in response to the mouse being lifted from the work surface.

15. A computer-implemented method comprising:
moving a first object along a virtual surface in a virtual space based on first data output in response to movement of a mouse on a work surface; and
moving the first object in a direction away from the virtual surface based on second data output in response to the mouse being lifted from the work surface.

16. The game system according to claim 14, wherein in the separation process, regardless of an amount that the mouse is lifted from the work surface, the first object is separated from the virtual surface by a predetermined movement amount.

17. The game system according to claim 14, wherein the mouse includes a first mouse and a second mouse, and the operations further comprise:
moving the first object along the virtual surface according to movement of the first mouse and the second mouse on the work surface; and
moving the first object in the direction away from the virtual surface in response to the first mouse and the second mouse being lifted from the work surface.

18. The computer-implemented method according to claim 15, wherein in the moving the first object in the direction away from the virtual surface, regardless of an amount that the mouse is lifted from the work surface, the first object is separated from the virtual surface by a predetermined movement amount.

19. The computer-implemented method according to claim 15, wherein the mouse includes a first mouse and a second mouse, and the method further comprises:
moving the first object along the virtual surface according to movement of the first mouse and the second mouse on the work surface; and
moving the first object in the direction away from the virtual surface in response to the first mouse and the second mouse being lifted from the work surface.
